(19) United States
(12) Patent Application Publication
(10) Pub. No.: US 2009/0153647 A1
(43) Pub. Date: Jun. 18, 2009

(54) METHOD AND DEVICE FOR GENERATING A PANORAMIC IMAGE FROM A VIDEO SEQUENCE

(75) Inventor: Stephane Auberger, Noisy-Le-Grand (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/298,153

(22) PCT Filed: Apr. 23, 2007
(86) PCT No.: PCT/IB07/51479

§ 371 Date: Oct. 23, 2008

(30) Foreign Application Priority Data
Apr. 24, 2006 (EP) 06300398.2

(51) Int. Cl. H04N 7/00

(52) U.S. Cl. 348/36; 348/E07.001

(57) ABSTRACT

The invention relates to a method and device for generating a panoramic image (3) from a video sequence composed of several consecutive images (I₀, I₁, Iₖ₋₁, Iₖ). The method comprises the following successive steps: —receiving on an input (4) a current image (I₁, Iₖ) having a first and a second portions (40, 42); —if the pixel of the current image is associated to components resulting from a weighted sum of components stem from a number of images lower than a predefined threshold (N), computing components resulting from the weighted sum of components associated to the identified pixel of the current image (I₁, Iₖ) and of components associated to the corresponding pixel of a so-called previous mix image.

### TECHNICAL FIELD OF THE INVENTION

The invention relates to a method of generating a panoramic image from a video sequence, and to a corresponding device for carrying out said generating method.

### BACKGROUND OF THE INVENTION

Panoramic images are commonly obtained by aligning and merging several images extracted from a video. Mosaicing methods have been developed, to that end, for aligning and merging the images. They work off-line on a computer. Although very efficient, they can be quite complex and computer intensive. Therefore, these methods are difficult to implement in a mobile device like mobile phones, key-rings or PDAs, which have low memory and energy capacities.

Therefore, it is desirable to develop a new method for generating a panoramic image which requires low memory and energy.

### SUMMARY OF THE INVENTION

Accordingly, it is an object of the invention to provide a method of generating a panoramic image from a video sequence composed of several consecutive images (I₀, I₁, Iₖ₋₁, Iₖ), each image (I₀, I₁, Iₖ₋₁, Iₖ) comprising at least one pixel associated to luminance and chrominance components, the method being performed by a device comprising a panoramic structure having pixels associated to components equal to zero, wherein the method comprises the following successive steps:
a) assigning components initialized to zero to pixels of an image (P₀, Pₖ₋₁) called previous mix image and storing the previous mix image (P₀, Pₖ₋₁) in the panoramic structure;
b) positioning a current image (I₁, Iₖ) having first and second portions into the panoramic structure with respect to the previous mix image (P₀, Pₖ₋₁), a first area of pixels of the current image (I₁, Iₖ) corresponding to an area of pixels of the previous mix image (P₀, Pₖ₋₁), a second area of pixels of the current image (I₁, Iₖ) corresponding to an area of pixels of the panoramic structure;
c) identifying pixels belonging to the first portion and to the first area of the current image (I₁, Iₖ);
d) for each identified pixel, if the identified pixel is associated to components resulting from a weighted sum of components stem from a number of images inferior to a predefined threshold (N),
   computing components resulting from the weighted sum of components associated to the identified pixel of the current image (I₁, Iₖ) and of components associated to the corresponding pixel of the previous mix image (P₀, Pₖ₋₁),
   assigning components to the corresponding pixel of the previous mix image (P₀, Pₖ₋₁) to obtain components associated to a pixel of a current mix image (P₁, Pₖ);
e) for each pixel belonging to the second portion and to the second area of the current image (I₁, Iₖ) assigning components associated to the pixel of the current image (I₁, Iₖ) to the corresponding pixel of the panoramic structure to obtain components associated to a pixel of the current mix image (P₁, Pₖ);
f) for each pixel belonging to the second portion and to the first area of the current image (I₁, Iₖ), assigning components associated to the pixel of the current image (I₁, Iₖ) to the corresponding pixel of the previous mix image (P₀, Pₖ₋₁) to obtain components associated to a pixel of a current mix image (P₁, Pₖ);
g) for each pixel belonging to the first portion and to the second area, assigning components associated to the pixel of the current image (I₁, Iₖ) to the corresponding pixel of the panoramic structure to obtain components associated to a pixel of a current mixed image (P₁, Pₖ); and
h) considering the pixels of the current mix image (P₁, Pₖ) as the pixels of the previous mix image (P₀, Pₖ₋₁) and repeating steps b) to h) until a stop condition is fulfilled.

Other features and advantages of the method are recited in the dependent claims.

It is also an object of the invention to provide, in order to carry out the method according to the invention, a device for generating a panoramic image from a video sequence composed of several consecutive images (I₀, I₁, Iₖ₋₁, Iₖ), each image (I₀, I₁, Iₖ₋₁, Iₖ) comprising at least one pixel associated to luminance and chrominance components, the device comprising:
a panoramic structure having pixels associated to components initialized to zero;
a computing block for assigning components initialized to zero to pixels of an image (P₀, Pₖ₋₁) called previous mix image and for storing the previous mix image (P₀, Pₖ₋₁) in the panoramic structure;
an input for receiving a current image (I₁, Iₖ) having a first and a second portions;
the computing block being adapted to position the current image (I₁, Iₖ) into the panoramic structure with respect to the previous mix image (P₀, Pₖ₋₁), a first area of pixels of the current image (I₁, Iₖ) corresponding to an area of pixels of the previous mix image (P₀, Pₖ₋₁), a second area of pixels of the current image (I₁, Iₖ) corresponding to an area of pixels of the panoramic structure;
the computing block being adapted to identify the pixels belonging to the first portion and to the first area of the current image (I₁, Iₖ);
for each identified pixel, the computing block being able to check if the identified pixel is associated to components resulting from a weighted sum of components stem from a number of images inferior to a predefined threshold (N),
the computing block being adapted to compute components resulting from the weighted sum of components associated to the identified pixel of the current image (I₁, Iₖ) and of components associated to the corresponding pixel of the previous mix image (P₀, Pₖ₋₁) and to assign components to the corresponding pixel of the previous mix image (P₀, Pₖ₋₁) to obtain components associated to a pixel of a current mix image (P₁, Pₖ);
for each pixel belonging to the second portion and to the second area of the current image (I₁, Iₖ), the computing block being able to assign components associated to the pixel of the current image (I₁, Iₖ) to the corresponding pixel of the panoramic structure to obtain components associated to a pixel of the current mix image (P₁, Pₖ);
for each pixel belonging to the second portion and to the first area of the current image (I₁, Iₖ), the computing block being adapted to assign components associated to the pixel of the current image (I₁, Iₖ) to the corresponding pixel of the previous mix image (P₀, Pₖ₋₁) to obtain components associated to a pixel of a current mix image (P₁, Pₖ); and
for each pixel belonging to the first portion and to the second area, the computing block being adapted to assign components associated to the pixel of the current image (I₁, Iₖ) to the corresponding pixel of the panoramic structure to obtain components associated to a pixel of a current mixed image (P₁, Pₖ), the computing block being adapted to consider the pixels of the current mix image (P₁, Pₖ) as the pixels of the previous mix image (P₀, Pₖ₋₁).

These and other aspects of the invention will be apparent from the following description, drawings and from the claims.

### BRIEF DESCRIPTION OF THE FIGURES

FIG. 1 is a schematic block diagram of a device according to the invention for generating a panoramic image from a video sequence;

FIG. 2 is a flow chart of a method such as carried out in the device of FIG. 1 according to the invention, for generating a panoramic image from a video sequence;

FIG. 3 is a schematic view showing the position of an image into a panoramic structure;

FIG. 4 is a schematic view of the current image;

FIG. 5 is a schematic view of an age structure storing for each pixel the number of images of the video sequence which have been mixed in the panoramic structure; and

FIG. 6 is a schematic view of the first and the second images merged and stored in the panoramic structure.

### DETAILED DESCRIPTION

The method and device according to the invention are described in an example where the video sequence has been obtained from a camera filming from the left to the right direction. However, the solution according to the invention can also be applied to a video sequence taken from the right to the left direction, by simply left/right mirroring the copy and mix areas defined hereafter.

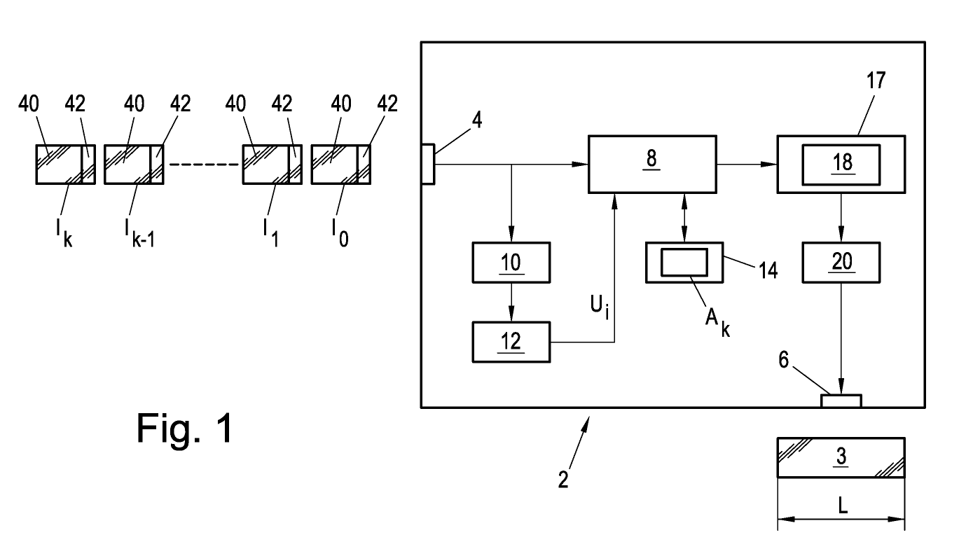

Referring to FIG. 1, a device 2 for generating a panoramic image 3 is illustrated. It comprises an input 4, for receiving consecutive images I₀, I₁, . . . Iₖ₋₁, Iₖ, Iₖ₊₁, etc, of the video sequence, and an output 6, for sending the generated panoramic image 3 to a presentation device such as for example a display screen of a camera or of a TV set. The images I₀, I₁ of the video sequence comprise a matrix of pixels arranged in columns and rows. Each pixel of the images is defined by coordinates x, y in the reference system Rₓ, R_{y} and by a luminance component and two chrominance components.

The device 2, constituted for example by a microprocessor, comprises a computing block 8 and a binarization block 10 both connected to the input 4, and a motion estimation block 12 connected to the binarization block 10 and to the computing block 8. The device 2 also comprises a temporary memory 14 linked to the computing block 8, a panoramic memory 17 connected to the computing block 8 and a cutting block 20 linked to the panoramic memory 17 and to the output 6. The temporary 14 and the panoramic 17 memories are for example a RAM or an EEPROM memory.

The temporary memory 14 is adapted to store an age structure Aₖ generated by the computing block 8. The age structure Aₖ comprises the reference system Rₓ, R_{y}. The value at the top left corner of the age structure Aₖ is at the origin of the reference system.

The panoramic memory 17 comprises a panoramic structure 18. The panoramic structure 18 is able to store the images previously received into a single merged panoramic image. The panoramic image 3 is progressively created in the panoramic structure 18 step by step by merging new incoming images and images already merged and stored in the panoramic structure 18, as explained later in the description.

A reference system Rₓ, R_{y} identical to the reference system Rₓ, R_{y} of the age structure Aₖ is associated the panoramic structure 18. The value at the top left corner of the age structure Aₖ is also at the origin of this reference system. In these reference systems Rₓ, R_{y}, the value of the age structure Aₖ is representative of the number of images merged at a pixel of the panoramic structure 18 having the same coordinates as the coordinates of the value of the age structure Aₖ.

The age structure Aₖ reflects the number and the position of images merged and stored in the panoramic structure 18. Since the images merged in the panoramic structure 18 are shifted in the right direction (direction of the movement of the camera), the number of images merged is not uniform and depend on the location of the pixels in the panoramic structure 18.

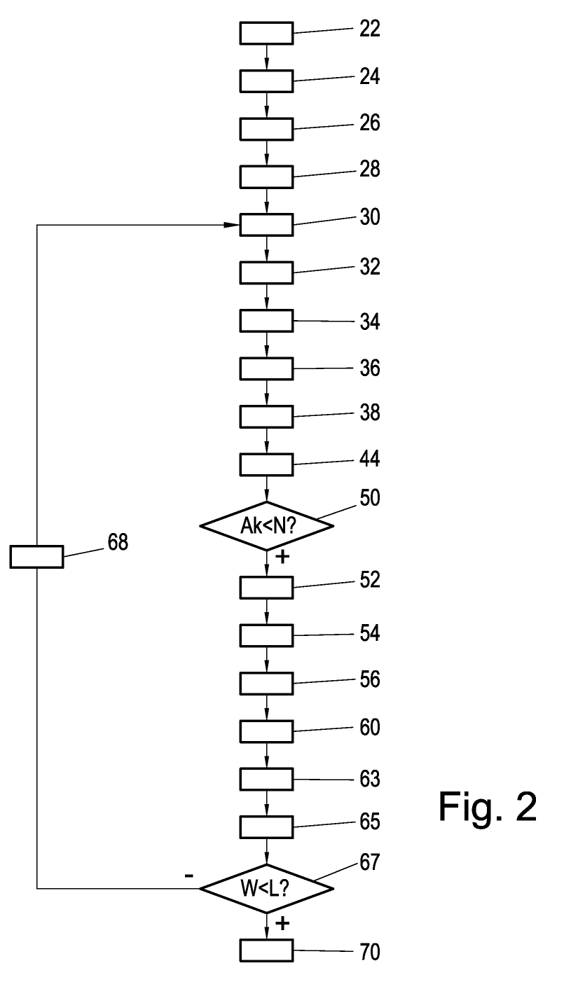

As illustrated in FIGS. 2 to 6, the method carried out by the device 2 for generating the panoramic image 3 comprises a first set of steps 22 to 28 performed on the two first images I₀, I₁ of the video sequence and a second set of steps 30 to 60 performed on each subsequent images Iₖ, Iₖ₋₁ of the video sequence. These second steps 30 to 60 are iterated for each image of the video sequence until the images merged and stored in the panoramic structure 18 have a predefined width which corresponds to the maximum width L allowed for the final panoramic image 3.

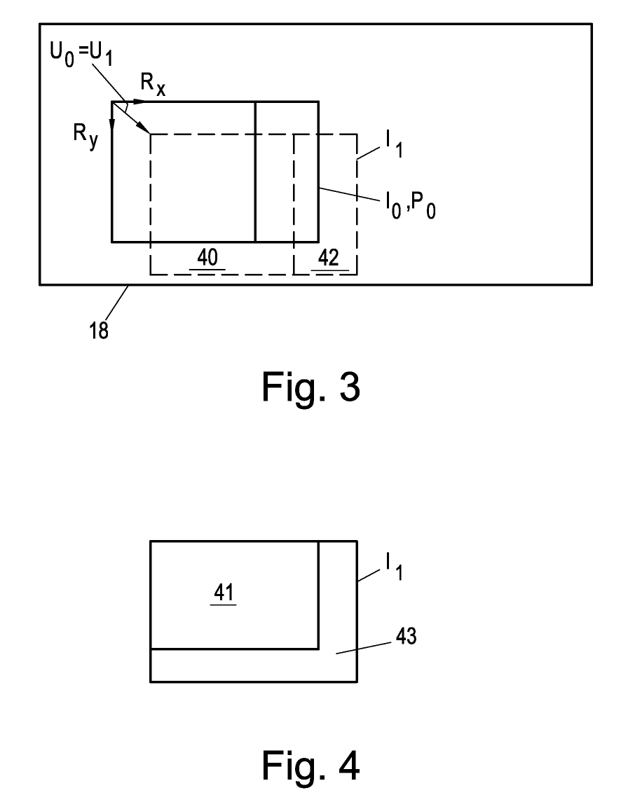

The method begins with a first step 22 of receiving an initial image I₀ from a set of consecutive images Iₖ, Iₖ₋₁ of the video sequence. The current image I₁ is considered as being composed of a mix portion 40 and of a copy portion 42. As visible in FIG. 3, the mix portion 40 is positioned on the left side of the image and the copy portion 42 is positioned at the right side of it. The copy portion 42 is constituted by a strip having a predefined width which is for example equal to ¼ of width of the current image I₁. The copy portion 42 is created to avoid using exclusively the image borders when creating the panoramic. When updating the panoramic new disappearing parts of the scene are always on the sides and these parts are often distorted because of the wide-angle lens or subject to luminance artefact such as vignetting.

At step 24, the initial image I₀ received from the input 4 is transmitted to the binarization block 10 and to the panoramic memory 17 via the computing block 8. During step 24, the components associated to each pixel of the initial image I₀ are stored in the panoramic structure 18 of the memory 17 at a location such that the pixel positioned at the upper left corner of the initial image I₀ is positioned at the origin of the reference system Rₓ, R_{y} as schematically represented in FIG. 3. The initial image I₀ stored in the panoramic structure 18 is considered as being a previous mix image P₀.

At step 26, the computing block 8 generates an age structure A₀ and stores it in the temporary memory 14. The age structure A₀ comprises values representatives of the number of images merged and stored in the panoramic structure 18. One value corresponding to one pixel of the images stored in the panoramic structure 18. The values of the age structure A₀ corresponding to the pixels of the first portion 40 of the initial image I₀ are equal to 1. The values of the age structure A₀ corresponding to the pixels of the second portion 42 of the initial image I₀ are left to 0.

At step 28, the binarization block 10 creates a binary image from the first image I₀ received. After, the obtained binary image is transmitted to the motion estimation block 12. Preferably, one bit image is generated because it considerably lowers the memory constraints. As well known, to create the binarized image the Sum of Absolute Differences (SAD) is calculated between a referenced block and other blocks by using XOR operations.

For example, Gray-coded bit planes decomposition is implemented in the following way:

F(x,y)=a_{N-1}2^{N-1}+a_{N-2}2^{N-2}+ . . . +aₖ2^{k}+ . . . +a₁2¹+a₀2⁰ (1)

where:
F(x,y) is the luminance of a pixel at location (x, y)
aₖ is either 0 or 1, and
N is the number of bit representing the luminance component.
   The 4^{th} Gray bit code g₄ is computed from the following equation: g₄=a₄⊕a₅ where ⊕ is the eXclusive OR operation and aₖ is the k-th bit of the base 2 representation given by equation (1).

At step 30, the second image I₁ is received from the input 4 of the device 2 and is transmitted simultaneously to the binarization block 10 and to the computing block 8. The second image I₁ is called current image in the following of the description.

At step 32, the binarization block 10 binarizes the current image I₁ and sends the obtained image to the motion estimation block 12.

At step 34, the motion estimation block 12 computes a global motion vector U₀ representative of the motion between the first image I₀ and the current image I₁ from the binarized first and current images. After, the global motion vector U₀ is sent to the computing block 8. To obtain a global motion vector U₀ of two consecutive images, different methods can be used.

One of them consists in considering the image I₀ and the subsequent image I₁ and determining a set of motion vectors of macro-blocks of these consecutive images. Each motion vector represents the movement of the same from one image I₀ to the subsequent image I₁, in each macro-block (typically, each macro-block comprises 16×16 pixels of the image).

The motion vectors are grouped, their internal consistency is checked, and areas containing independent motion (moving people or objects) are rejected. The median of the set of motion vectors of each pair of subsequent images I₀, I₁ is determined. This median vector is the global motion vector U₀ and represents the global movement of the camera realised between images I₀ and I₁. The global motion vector U₀ thus contains both the intentional motion (panoramic) and the unintentional one (high frequency jitter) that will be taken into account to correctly map the panoramic image 3.

At step 36, the global motion vector U₀ computed at step 32 is added to the previous estimated global motion vector U₋₁ to obtain a current global motion vector U₁. This step is performed by the computing block 8. At the first iteration of the method, the previous global motion vector U₋₁ is equal to zero. The current global motion vector U₁ is equal to the global motion vector U₀ because the images I₀ and I₁ are the first and the second images of the video sequence.

During the next iteration of the method, the global motion vector Uᵢ is added to the previous estimated global motion vector Uᵢ₋₁ to obtain a current global motion vector Uᵢ₊₁. The current global motion vector Uᵢ₊₁ computed during an iteration is considered as the previous global motion vector for the computing of the current global motion vector Uᵢ₊₂ during the next iteration.

At step 38, the current image I₁ is positioned into the panoramic structure 18 with respect to the previous mix image P₀ (which is the initial image I₀) so as to be displaced from a quantity corresponding to the global motion vector U₀. In this position, the pixels of a first area 41 are positioned in front of the previous mix image P₀. The pixels of a second area 43 are positioned in front of the panoramic structure 18.

It is considered that a pixel of the current image I₁ in front of a pixel of the previous mix image corresponds to this pixel and a pixel of the current image I₁ in front of a pixel of the panoramic structure corresponds to this pixel. So, each pixel of the current image I₁ corresponds to a pixel of the previous mix image P₀ or to a pixel of the panoramic structure 18. The first 41 and the second 43 areas of the current image I₁ are defined such that the pixels of the first area 41 correspond to pixels of an area of the previous mix image and the pixels of the second area 43 corresponds to pixels of an area of the panoramic structure 18 as shown in FIG. 4.

At step 44, the age structure A₀ is updated and becomes an age structure A₁. To this end, the values of the age structure A₀ having the same coordinates in the reference system Rₓ, R_{y}, than the pixels belonging to the first portion 40 are incremented from one.

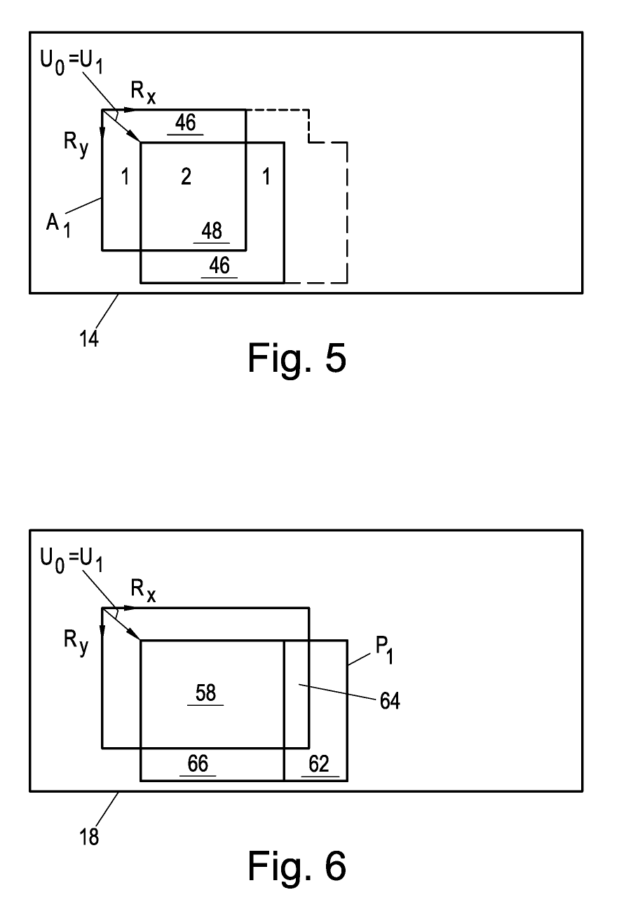

The values corresponding to the pixels of the first portion 40 of the current image I₁ superimposed on the first portion 40 of the previous mix image P₀ are equal to 2. The values corresponding to the pixels of the first portion 40 of the current image I₁ superimposed on the empty panoramic structure 18 and the value corresponding to the pixels superimposed on the second portion 42 of the previous mixed image P₀ are equal to 1. As shown in FIG. 5, the updated age structure A₁ comprises one portion referenced 46 and having values equal to 1 and one portion referenced 48 having values equal to 2.

At step 50, the computing block 8 scans the values of the age structure A₁ corresponding to the pixel of the first 40 portion of the current image I₁ from left to right and checks if one of these values is superior to a predetermined threshold N also called mix value N. If one of the values of the age structure A₁ is superior to the mix value N, the computing block 8 continues with scanning the age structure A₁ from left to right, from a position corresponding to the first portion 40 until finding a defined value inferior to the mix value. If one of the values of the age structure A₁ is inferior or equal to the mix value N, the process goes to step 52.

At step 52, the computing block 8 identifies the pixels belonging to the first portion 40 and to the first area 41 and having a corresponding value inferior or equal to the mix value N.

At step 54, the computing block 8 computes components resulting from the weighted sum of components associated to the identified pixel of the current image I₁ and of components associated to the corresponding pixel of the previous mix image P₀. For each pixel belonging to the first portion 40 and to the first area 41 of the current image I₁, the weighted sum is obtained from the following relation:

$${P}_{1} ( x , y ) = \frac{( {A}_{1} ( x , y ) - 1 ) \times {P}_{0} ( x , y ) + {I}_{1} ( x , y )}{{A}_{1} ( x , y )}$$

where:
P₁(x,y) is the component associated to a pixel of the current mix image, the pixel being positioned at coordinates (x,y) in the reference system;
P₀(x,y) is the components associated to the corresponding pixel of the previous mix image;
A₁(x,y) is the value associated to the pixel having coordinates (x,y) in the reference system of the age structure; and
I₁(x,y) is the components associated to the pixel of the current image.

For the next iteration of the method, the above relation is generalized as follows:

$${P}_{k} ( x , y ) = \frac{( ( {A}_{k} ( x , y ) - 1 ) \times {P}_{k - 1} ( x , y ) + {I}_{k} ( x , y ) )}{{A}_{\underline{k}} ( x , y )}$$

where:
(x, y) is the coordinates of a pixel;
Pₖ is the components assigned to a pixel of the current mix image;
Pₖ₋₁ is the components associated to a pixel of the previous mix image;
Aₖ is the number of time that components have been assigned to a pixel of the previous mix image; and
Iₖ is the components associated to a pixel of the current image.

At step 56, the components obtained at step 54 are assigned to the corresponding pixel of the previous mix image P₀ to obtain components associated to a pixel of a part 58 of a current mix image as shown in FIG. 6.

At step 60, for each pixel belonging to the second portion 42 and to the second area 43 of the current image I₁, the computing block 8 assigns components associated to the pixel of the current image I₁ to the corresponding pixel of the panoramic structure 18 to obtain components associated to a pixel of a part 62 of the current mix image P₁ (FIG. 6).

At step 63, for each pixel belonging to the second portion 42 and to the first area 41 of the current image I₁, the computing block 8 assigns components associated to the pixel of the current image I₁ to the corresponding pixel of the previous mix image P₀ to obtain components associated to a pixel of a part 64 of the current mix image P₁ (FIG. 6).

At step 65, for each pixel belonging to the first portion 40 and to the second area 43 of the current image I₁, the computing block 8 assigns components associated to the pixel of the current image I₁ to the corresponding pixel of the panoramic structure 18 to obtain components associated to a pixel of a part 66 of the current mix image P₁ (FIG. 6).

At step 67, the computing block 12 checks if all images merged and stored in the panoramic structure 18 at each iteration of method have a width equal or superior to the width L expected for the final panoramic image 3. If the width of the images stored is less large than the width L of the panoramic image 3, the process returns to step 30 during step 68, otherwise the process goes to step 70 (this step can be reached also if there a no more images Iₖ).

At step 70, the cutting block 20 search the pixels associated to luminance and chrominance components and having the lowers and the highest ordinates y in the reference system Rₓ, R_{y} and cut the upper and lower borders of the generated image 3 to obtain a rectangular picture.

When the process returns to step 30 for a new iteration, the computing block 8 increments a counter at step 68. After a predefined number of iterations, the sizes of the first portion 40 and the second portion 42 are modified according to a predefined function. For example, the mix area 40 corresponds to the left ¾ part of the Image until ¼ of the width of the panoramic image 3 has been created, and gradually diminishes to only the left ¼ part of the Image (the second copy portion increasing accordingly) after ¾ of the width of the panoramic image 3 has been created. In another embodiment, the sizes of the first portion 40 and the second portion 42 are constants. In a variant, the age structure can consist of one line of width L pixels only (all pixels of one column in the panoramic image are considered to have the same age). In this case, the y ordinate of the U vector is not taken into account. This greatly reduce memory needed and would create artefacts only at top and bottom of the panoramic image only, in parts that are cut by step 70.

Obviously, there are numerous ways of implementing the functions described above by means of items of hardware or software, or both. In this respect, the drawings are very diagrammatic and represent only one possible embodiment of the invention. Thus, although FIGS. 1 and 2 show different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of generating a panoramic image from a video sequence composed of several consecutive images, each image comprising at least one pixel associated to luminance and chrominance components, the method being performed by a device comprising a panoramic structure having pixels associated to components equal to zero, wherein the method comprises the following successive steps:
a) assigning components initialized to zero to pixels of an image called previous mix image and storing the previous mix image in the panoramic structure;
b) positioning a current image having first and second portions into the panoramic structure with respect to the previous mix image, a first area of pixels of the current image corresponding to an area of pixels of the previous mix image, a second area of pixels of the current image corresponding to an area of pixels of the panoramic structure;
c) identifying pixels belonging to the first portion and to the first area of the current image;
d) for each identified pixel, if the identified pixel is associated to components resulting from a weighted sum of components stem from a number of images inferior to a predefined thresholds,
computing components resulting from the weighted sum of components associated to the identified pixel of the current image and of components associated to the corresponding pixel of the previous mix image,
assigning components to the corresponding pixel of the previous mix image to obtain components associated to a pixel of a current mix image;
e) for each pixel belonging to the second portion and to the second area of the current image assigning components associated to the pixel of the current image to the corresponding pixel of the panoramic structure to obtain components associated to a pixel of the current mix image;
f) for each pixel belonging to the second portion and to the first area of the current image, assigning components associated to the pixel of the current image to the corresponding pixel of the previous mix image to obtain components associated to a pixel of a current mix image;
g) for each pixel belonging to the first portion and to the second area, assigning components associated to the pixel of the current image to the corresponding pixel of the panoramic structure to obtain components associated to a pixel of a current mixed image; and
h) considering the pixels of the current mix image as the pixels of the previous mix image and repeating steps b) to h) until a stop condition is fulfilled.

2. A method according to claim 1, wherein the method comprises the following steps:
i) considering a previous image; and
j) computing a global motion vector representative of the motion between the previous image and the current image, the current image being positioned into the panoramic structure with respect to the previous mix image according to the global motion vector.

3. A method according to claim 1, wherein components associated to the pixels of the first portion of the previous mixed image and to the pixels of the first portion of the current image are weighted with the same weight in the current mixed image.

4. A method according to claim 1, wherein components associated to a pixel of the current mix image are obtained at step e) from the following relation:
$${P}_{k} ( x , y ) = \frac{( ( {A}_{k} ( x , y ) - 1 ) \times {P}_{k - 1} ( x , y ) + {I}_{k} ( x , y ) )}{{A}_{\underline{k}} ( x , y )}$$
in which:
(x, y) is the coordinates of the pixel;
Pₖ is the components assigned to the pixel of the current mix image;
Pₖ₋₁ is the components associated to the pixel of the previous mix image;
Aₖ is the number of time that components have been assigned to the pixel of the previous mix image; and
Iₖ is the components associated to the pixel of the current image.

5. A method according to claim 1, wherein it comprises the following steps:
generating an age structure comprising values, each value of the age structure corresponding to a pixel of the panoramic structure or of the previous mix image, each value being representative of the number of time that components have been assigned to a pixel of the panoramic structure or of the previous mix image;
updating the age structure;
scanning the values of the age structure, if a value is greater than the predefined threshold;
repeating steps b) and c) until the current image is positioned into the panoramic structure at a location where the pixel correspond to a value inferior to the predefined threshold.

6. A method according to claim 1, wherein the frontier between the first portion and the second portion varies with respect to the emplacement of positioning of the current image into the panoramic structure.

7. A method according to claim 1, wherein the method has been applied to all images of the video sequence.

8. A method according to claim 1, wherein it comprises a step of binarizing the previous image and the current image and wherein the step of computing of the global motion vector is performed on the binarized images.

9. A method according to claim 1, wherein it comprises a step of cutting the top and the low border of the generated panoramic images.

10. A device for generating a panoramic image from a video sequence composed of several consecutive images, each image comprising at least one pixel associated to luminance and chrominance components, the device comprising:
a panoramic structure having pixels associated to components initialized to zero;
a computing block for assigning components initialized to zero to pixels of an image called previous mix image and for storing the previous mix image in the panoramic structure;
an input for receiving a current image having a first and a second portions;
the computing block being adapted to position the current image into the panoramic structure with respect to the previous mix image, a first area of pixels of the current image corresponding to an area of pixels of the previous mix image, a second area of pixels of the current image corresponding to an area of pixels of the panoramic structures;
the computing block being adapted to identify the pixels belonging to the first portion and to the first area of the current image;
for each identified pixel, the computing block being able to check if the identified pixel is associated to components resulting from a weighted sum of components stem from a number of images inferior to a predefined threshold,
the computing block being adapted to compute components resulting from the weighted sum of components associated to the identified pixel of the current image and of components associated to the corresponding pixel of the previous mix image and to assign components to the corresponding pixel of the previous mix image to obtain components associated to a pixel of a current mix image;
for each pixel belonging to the second portion and to the second area of the current image, the computing block being able to assign components associated to the pixel of the current image to the corresponding pixel of the panoramic structure to obtain components associated to a pixel of the current mix image;
for each pixel belonging to the second portion and to the first area of the current image, the computing block being adapted to assign components associated to the pixel of the current image to the corresponding pixel of the previous mix image to obtain components associated to a pixel of a current mix image; and
for each pixel belonging to the first portion and to the second area, the computing block being adapted to assign components associated to the pixel of the current image to the corresponding pixel of the panoramic structure to obtain components associated to a pixel of a current mixed image, the computing block being adapted to consider the pixels of the current mix image as the pixels of the previous mix image.
